(19) United States
(12) Patent Application Publication
(10) Pub. No.: US 2019/0392731 A1
(43) Pub. Date: Dec. 26, 2019

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Fumiki OHTANI, Toyota-shi (JP); Hirofumi KAMIMARU, Fukuoka-shi (JP); Riho MATSUO, Nagoya-shi (JP); Shodai KATO, Toyota-shi (JP); Atsushi YOSHIDA, Tokyo (JP); Shunsuke TANIMORI, Susono-shi (JP)

(73) Assignee: TOYOTA JIDOSHA KABUSHIKI KAISHA, Toyota-shi (JP)

(21) Appl. No.: 16/425,107

(22) Filed: May 29, 2019

(30) Foreign Application Priority Data
Jun. 21, 2018 (JP) 2018-117767

(51) Int. Cl. G09B 19/16; G09B 19/14; G09B 5/00

(52) U.S. Cl. CPC G09B 19/167; G09B 5/00; G09B 19/14

(57) ABSTRACT

Learning effects are increased in a case where a learning is performed between multiple users in a carpool vehicle. An information processing apparatus includes a control unit. The control unit, in a case where a learning between multiple carpool users who are users in a carpool in a same vehicle is to be performed in the vehicle, matches the multiple carpool users to join the carpool in the vehicle, based on information about learning levels of multiple demanding users who are users demanding the carpool in the vehicle.

### CROSS REFERENCE TO RELATED APPLICATION

This application claims the benefit of Japanese Patent Application No. 2018-117767, filed on Jun. 21, 2018, which is hereby incorporated by reference herein in its entirety.

### BACKGROUND

### Technical Field

The present disclosure relates to an information processing apparatus, an information processing method, and a program.

### Description of the Related Art

A way of traveling is known in which multiple users ride in the same vehicle together (for example, Patent document 1).

### CITATION LIST

### Patent Document

[Patent document 1] U.S. Patent Application Publication No. 2017/0351990

### SUMMARY

An objective of the present disclosure is to increase learning effects in a case where a learning is performed between multiple users in a carpool vehicle.

One aspect of the present disclosure is an information processing apparatus including a control unit. The control unit, in a case where a learning between multiple carpool users who are users in a carpool in a same vehicle is to be performed in the vehicle, matches the multiple carpool users to join the carpool in the vehicle, based on information about learning levels of multiple demanding users who are users demanding the carpool in the vehicle.

Aspects of the present disclosure include the disclosure of a method and the disclosure of a program related to the information processing apparatus.

The present disclosure can increase learning effects in a case where a learning is performed between multiple users in a carpool vehicle.

### BRIEF DESCRIPTION OF THE DRAWINGS

FIG. 1 is a diagram illustrating a schematic configuration of a carpool support system according to a first embodiment;

FIG. 2 is a block diagram schematically illustrating one example of configurations of an in-car apparatus, a user terminal, and a server constituting the carpool support system according to the first embodiment;

FIG. 3 is a diagram illustrating an example of the functional configuration of the server;

FIG. 4 is a diagram illustrating an example of a table configuration of travel information about a driving user;

FIG. 5 is a diagram illustrating an example of the table configuration of travel information about a passenger user;

FIG. 6 is a diagram illustrating an example of the table configuration of status information according to the first embodiment;

FIG. 7 is a diagram illustrating an example of a functional configuration of the user terminal;

FIG. 8 is a diagram illustrating one example of a screen for inputting user information, travel information, and status information shown on an output unit of the user terminal;

FIG. 9 is a diagram illustrating an example of a functional configuration of the in-car apparatus;

FIG. 10 is a flow chart of matching processing according to the first embodiment;

FIG. 11 is a flow chart illustrating a flow for a travel path generating processing according to the first embodiment; and

FIG. 12 is a diagram illustrating a flow of the operation of the carpool support system.

### DESCRIPTION OF THE EMBODIMENTS

The information processing apparatus which is one aspect of the present disclosure matches multiple carpool users among multiple users demanding a carpool (demanding users), based on information about the learning levels of the users. Here, matching is to set a combination of users to ride or the same vehicle. Note that a combination of a vehicle and a user may be set through matching. Thus, multiple users are allowed to join a carpool according to their learning levels. A learning may be performed between multiple users in a carpool. Alternatively, a teacher other than the multiple users in the carpool may exist. When a teacher exists, the teacher is present or absent in the same vehicle. In a case where the teacher is not in the same vehicle, a class may be given through a display or the like. Note that demanding users does not include teachers. Providing a learning in a vehicle in this manner promotes a carpool in the vehicle. A learning level is a degree of attainment; for example, a user is given a predetermined test, and the higher the score of the test is, the higher the learning level is determined. Aside from that, in a case where learning materials with different levels exist, a learning level may be determined depending on the levels of learning materials that have been done. When users to join a carpool are selected according to information about learning levels, the users with a comparable learning level can receive a learning together, for example, which increases the learning effects for each user. Note that users who do not join a learning may ride in the vehicle. Users who join a learning may but may not necessarily include a driver. The vehicle may be an automatic driving vehicle without a driver. The control unit can also match multiple carpool users among multiple demanding users so that a difference between the learning levels of the multiple carpool users falls within a predetermined range. The predetermined range is a range of difference between learning levels within which effective learnings can be given.

Here, in a case where users having greatly different learning levels join a carpool for a learning, the contents of learning that the users demand greatly differ, and all the users do not therefore always have a chance to take a demanded contents of learning. For this reason, at least part of users may obtain low learning effects. In contrast, when users are selected based on information about learning levels, the users with a comparable learning level can join a carpool together, which increases the learning effects for each user.

Concrete embodiments of the present disclosure will now be described with reference to the accompanying drawings. Dimensions, materials, shapes, relative positions, and the like of components described in the embodiments are not intended to limit the technical scope of the present disclosure thereto unless otherwise noted.

### First Embodiment

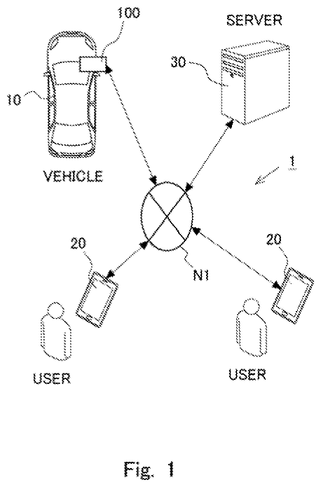

FIG. 1 is a diagram illustrating a schematic configuration of a carpool support system 1 according to this embodiment. The carpool support system 1 performs matching so that multiple users ride on one vehicle 10, and generates a travel path along which matched users can ride. In a case where users demand a certain learning, matching is performed so that users with a comparable learning level can join a carpool together. Note that the driver of the vehicle 10 will hereinafter be referred to as a “driving user”, and the carpool partners other than the driving user (non-drivers) are referred to as “passenger users”. When not distinguished from each other, the driving user and passenger users are simply referred to as a “user”. Besides, this embodiment is applicable to automatic driving vehicles (hereinafter referred to as automatic driving vehicles), and in this case, there is no driving user.

Before user matching, the server 30 acquires information about, user's learning level (hereinafter simply referred to as “acquire a learning level”). For example, users are given a test of a learning objective. This test may be performed on the user terminals 20. This test score is transmitted from the user terminal 20 to the server 30. Note that each user may input the score of a test performed by a predetermined organization to the user terminal 20, and this test score may be transmitted from the user terminal 20 to the server 30. The score of the test performed by the predetermined organization may be transmitted from each terminal possessed by the predetermined organization to the server 30. Each user terminal 20 or the in-car apparatus 100 of the vehicle 20 may acquire user's sound (voice) and transmit it to the server 30 and the server 30 may acquire a learning level based on this sound. Each user terminal 20 or the in-car apparatus 100 of the vehicle 10 may take an image of the user or his/her belongings and transmit it to the server 30 and the server 30 may acquire a learning level based on the taken image. Each user may input his/her subjective learning level to the user terminal 20 and the user terminal 20 may transmit it to the server 30. In a case where a learning is given using a learning material, learning levels can be acquired depending on learning materials that have been already done. For example, each user may input the number of volumes or pages that he/she has done to the user terminal 20 and the user terminal 20 may transmit it to the server 30. In this case, the larger the number of volumes or pages that he/she has done is, the higher the learning level is.

Subsequently, the server 30 matches the multiple users to ride in the vehicle 10 among the demanding users, based on information about the acquired learning levels. Upon completion of matching of multiple users, the server 30 generates a travel path of the vehicle 10. This travel path is transmitted to the user terminals 20 or the in-car apparatus 300 of the vehicle 10. Note that the user terminals 20 or the in-car apparatus 100 of the vehicle 10 may just show the received travel path or guide the travel direction of the vehicle 10 along the received travel path.

The following description is based on the assumption that the multiple users have an English lesson together as a learning in the vehicle 10. For example, the English lesson as a learning is given in such a manner that conversation in other than English is prohibited in the vehicle 10 for the carpool. Further, the description below is based on the assumption that the users have taken a predetermined test in advance and the users input the score to the user terminal 20. In this case, a teat score corresponds to a learning level.

In the example illustrated in FIG. 1, the carpool support system 1 includes an in-car apparatus 100 installed in the vehicle 10, user terminals 20, and a server 30. The in-car apparatus 100, the user terminals 20, and the server 30 are connected to each other via a network N1. Note that the network N1 is, for example, a worldwide public communication network, such as the Internet, and may be a wide area network (WAN) or other communication networks. In addition, the network N1 may include a telephone communication network such as that for cellular phones, or a wireless communication network such as WiFi. Although two user terminals 20 are illustrated in FIG. 1, demanding users each possess a user terminal 20 and as many user terminals 20 as demanding users exist. Further, although a single vehicle 10 is illustrated in FIG. 1, more than one vehicles 10 exist.

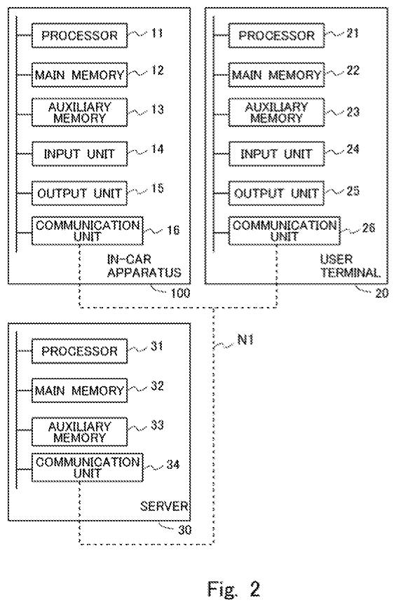

Hardware configurations and functional configurations of the in-car apparatus 100, the user terminals 20, and the server 30 will now be described with reference to FIG. 2. FIG. 2 is a block diagram schematically illustrating one example of configurations of the in-car apparatus 100, the user terminals 20, and the server 30 constituting the carpool support system 1 according to this embodiment.

The server 30 has a typical computer configuration. The server 30 includes a processor 31, a main memory 32, an auxiliary memory 33, and a communication unit 34. They are connected to each other via a bus.

The processor 31 is a central processing unit (CPU), a digital signal processor (DSP), or the like. The processor 31 controls the server 30 and performs various logic operations for information processing. The processor 31 functions as a control unit. The main memory 32 is a random access memory (RAM), read only memory (ROM), or the like. The auxiliary memory 33 is an erasable programmable ROM (EPROM), a hard disk drive (HDD), a removal medium, or the like. The auxiliary memory 33 stores an operating system (OS), various programs, various tables, and the like. The processor 31 loads the programs stored in the auxiliary memory 33 onto the work area of the main memory 32 and executes it, and the components are controlled through this execution of the programs. Thus, the server 30 implements a function meeting a predetermined objective. The main memory 32 and the auxiliary memory 33 are computer-readable recording media. Note that the server 30 may be a single computer or multiple computers in cooperation. Information stored in the auxiliary memory 33 may be stored in the main memory 32. Information stored in the main memory 32 may be stored in the auxiliary memory 33.

The communication unit 34 is a unit configured to communicate with the user terminals 20 and the in-car apparatus 100 via the network N1. The communication unit 34 is, for example, a wireless communication circuit for a local area network (LAN) interface board or wireless communication. The LAN interface board or the wireless communication circuit is connected to the network N1.

Note that a sequence of processing executed in the server 30 can be executed with hardware or software.

The user terminals 20 will now be described. Each user terminal 20 is, for example, a smartphone, a cellular phone, a tablet terminal, a personal information terminal, a wearable computer (such as a smartwatch), a personal computer (PC), or other compact computers. Each user terminal 20 includes a processor 21, a main memory 22, an auxiliary memory 23, an input unit 24, an output unit 25, and a communication unit 26. They are connected to each other via a bus. Description of the processor 21, the main memory 22, and the auxiliary memory 23, which are similar to the processor 31, the main memory 32, and the auxiliary memory 33 in the server 30, will be omitted.

The input unit 24 is a unit configured to receive an input operation from a user, for example, a touch screen, a push-button, or the like. The output unit 25 is a unit configured to show information to the user, for example, a liquid crystal display (LCD), an electroluminescence (EL) panel, a speaker, a lamp, or the like. The input unit 24 and the output unit 25 may constitute one touch screen display. The communication unit 26 is a communication unit configured to connect the user terminals 20 to the network N1. The communication unit 26 is, for example, a circuit for communication with other devices (for example, the server 30) via the network N1 by utilizing a mobile communication service (a telecommunication network, such as 3rd Generation (3G) or long term evolution (LTE), or a wireless communication, such as WiFi).

The in-car apparatus 100 of the vehicle 10 will now be described. The in-car apparatus 100 includes a processor 11, a main memory 12, an auxiliary memory 33, an input unit 14, an output unit 15, and a communication unit 16. They are connected to each other via a bus. They are similar to the processor 21, the main memory 22, the auxiliary memory 23, the input unit 24, the output unit 25, and the communication unit 26 of the user terminal 20, and their description will therefore be omitted.

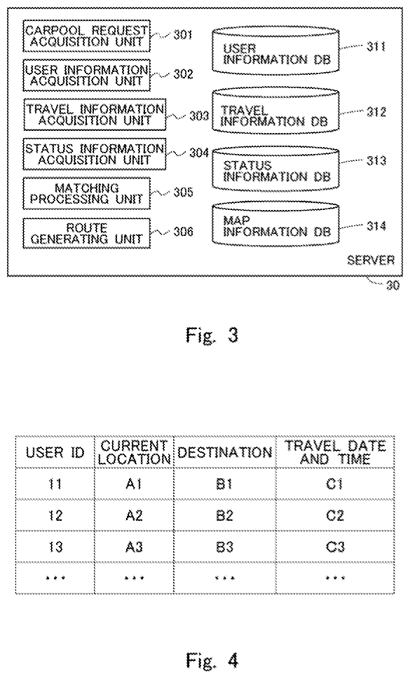

A function of the server 30 will now be explained. FIG. 3 is a diagram illustrating an example of a functional configuration of the server 30. The server 30 includes, as functional components, a carpool request acquisition unit 301, a user information acquisition unit 302, a travel information acquisition unit 303, a status information acquisition unit 304, a matching processing unit 305, a route generating unit 306, a user information DB 311, a travel information DB 312, a status information DB 313, and a map information DB 314. The processor 31 in the server 30 executes processing in the carpool request acquisition unit 301, the user information acquisition unit 302, the travel information acquisition unit 303, the status information acquisition unit 304, the matching processing unit 305, and the route generating unit 306, using computer programs in the main memory 32. Note that any one of the functional components or part of their processing may be executed with a hardware circuit.

The user information DB 311, the travel information DB 312, the status information DB 313, and the map information DB 314 are constructed when programs in a database management system (DBMS) executed by the processor 31 manage data stored in the auxiliary memory 33. The user information DB 311, the travel information DB 312, the status information DB 313, and the map information DB 314 are, for example, a relational database.

Note that any one of the functional components of the server 30 or part of their processing may be executed with a different computer connected to the network N1.

The carpool request acquisition unit 301 acquires a carpool request from a user who demands a carpool (a demanding user). Examples of this user include driving users and passenger users. A carpool request is information that includes a user's identifier and is used to request matching between the user and other users. A carpool request is transmitted from the user terminal 20 to the server 30. The user information acquisition unit 302 acquires information of the user that transmits the carpool request (user information). The user information includes, for example, a user ID associated with the user. The user ID is an identifier unique to each user. User information corresponding to the user ID (for example, a name and address, information indicating whether the user is a driving user or a passenger user, and in a case where the user is a driving user, a car type, vehicle color, vehicle number, vehicle capacity, and the like) may be pre-registered by the user through the user terminal 20 or may be transmitted from the user terminal 20 together with the carpool request. This user information is stored in the user information DB 311. The user information DB 311 is made up with the user information stored in the auxiliary memory 33 and is where association between the user and the user information is performed.

The travel information acquisition unit 303 acquires travel information about a user who demands a carpool. The travel information is information that is transmitted from the user terminal 20 to the server 30 together with the carpool request, and is related to a user's current location, destination, and travel date and time. Upon acquisition of travel information, the travel information acquisition unit 303 stores the travel information in the travel information DB 312. The travel information DB 312 is made up with the travel information stored in the auxiliary memory 33 and is where association between the user and the travel information is performed.

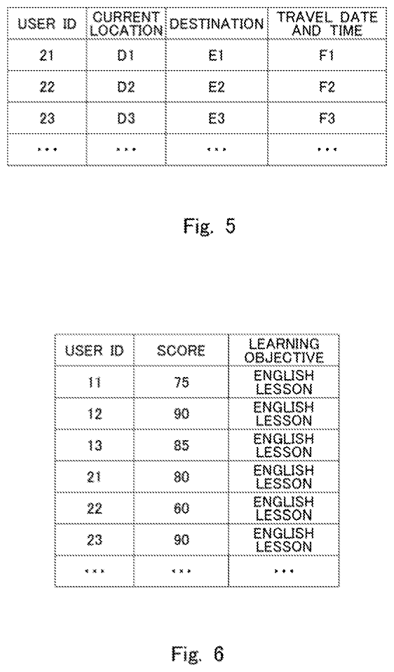

A structure of travel information stored in the travel information DB 312 will now be described with reference to FIGS. 4 and 5. FIG. 4 is a diagram illustrating an example of a table configuration of travel information about a driving user. FIG. 5 is a diagram illustrating an example of the table configuration of travel information about a passenger user. Note that information indicating whether the user who demands a carpool is a driving user or a passenger user may be prestored in the user information DE 311 in the state where it is associated with the user ID or may be included in the travel information or status information which will be described later. In a case of an automatic driving vehicle, all users are treated as passenger users. A driving user travel information table and a passenger user travel information table each include the fields of user ID, current location, destination, and travel date and time. In the user ID field, identification information for identifying users is input. In the current location field, information indicating the current locations of users is input. Note that, a current location of a passenger user may be a location where he/she demands to get the vehicle 10. In the driving user's current location field, information indicating the current location of the vehicle 10 may be input. In the destination field, information indicating the destinations of users is input. The current location and the destination are, for example, represented by a latitude and a longitude. In the travel date and time field, information indicating a desired date and time of a carpool is input. Regarding a case, for example, where multiple users having the same destination and travel date and time join a carpool such as where employees of the same company join a carpool to commute in the morning, input of the destination and travel date and time may be omitted.

Next, the status information acquisition unit 304 acquires status information about a user who demands a carpool. Status information is information transmitted from the user terminal 20 to the server 30 together with the carpool request, and is information generated based on the user's score of the predetermined test (hereinafter referred to as score information) and information related to a learning objective of the user. The score information represents the score and relates to the learning level. Upon acquisition of the status information, the status information acquisition unit 304 stores the status information in the status information DB 313. The status information DB 313 is made up with the status information stored in the auxiliary memory 33 and is where association between the user and the status information is performed.

The structure of the status information stored in the status information DB 313 will now be described with reference to FIG. 6. FIG. 6 is a diagram illustrating an example of the table configuration of the status information. A status information table includes fields of user IDs, the teat score, the learning objective. In the user ID field, identification information for identifying users is input. In the test score field, user's score information of the predetermined test is input. In the example illustrated in FIG. 6, the higher the score is, the higher learning level the user has. In the learning objective field, information indicating an objective of learning the user demanding a carpool desires is input. A learning objective is information corresponding to the content of a learning that the user demands to receive. Although an English lesson is given as an example of a learning objective in FIG. 6, a learning objective may be any objective aimed at mastering knowledge or skills and not limited to an English lesson. Users having no learning objective may exist. For users having no learning objective, information indicating the absence of a learning objective may be input or nothing may be input in the score field.

The matching processing unit 305 will now be described. The matching processing unit 305 performs matching between a driving user and passenger users. The matching processing unit 305 searches for passenger users whose current location and destination are within an area a predetermined distance from a scheduled route of the travel of the driving user on the driving user's travel date and time. Note that, in a case of an automatic driving vehicle, passenger users whose current location and destination are within an area a predetermined distance from a scheduled route of the travel of the vehicle 10 are searched. The scheduled route of the travel is generated based on current location and destination of the driving user (which may be the vehicle 10) and the map information stored in the map information DB 314. Note that the predetermined distance is a distance suitable for a carpool, and the area a predetermined distance away is, for example, an area in the same district. Further, the matching processing unit 305 compares each user's status information, and matches users having the same learning objective. Further, the matching processing unit 305 performs a comparison between pieces of the status information about the users and matches users so that the user with highest score and the user with the lowest score have a difference in a score within a predetermined range (for example, 10 points). The predetermined range here is a range of difference in the score within which effective learnings can be given. Note that the map information DB 314 stores, as the map information, for example, link data on roads (links), node data on node points, intersection data on intersections, search data for searching for routes, facility data on facilities, search data for searching for locations, and the like.

The route generating unit 306 generates a travel path of the vehicle 10 passing the current locations and destinations of the users matched through the matching processing unit 305. The travel path is generated based on each user's current location and destination and the map information stored in the map information DB 314. The travel path is generated so that it can be a path according to predetermined rules, such as a path along which the shortest travel distance of the vehicle 10 is achieved or a path along which the shortest travel time of the vehicle 10 is achieved. The route generating unit 306 transmits the generated travel path to the in-car apparatus 100 of the vehicle 10 or the user terminals 20.

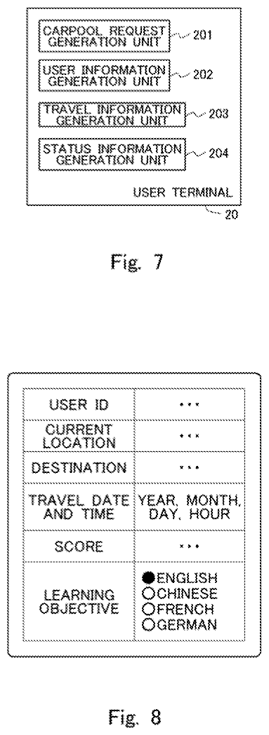

A function of the user terminal 20 will now be explained. FIG. 7 is a diagram illustrating an example of a functional configuration of the user terminal 20. Each user terminal 20 includes, as functional components, a carpool request generation unit 201, a user information generation unit 202, a travel information generation unit 203, and a status information generation unit 204. The processor 21 in the user terminal 20 executes processing in the carpool request generation unit 201, the user information generation unit 202, the travel information generation unit 203, and the status information generation unit 204, using computer programs in the main memory 22. Note that any one of the functional components or part of their processing may be executed with a hardware circuit.

The carpool request generation unit 201 shows an operating screen on the output unit 25 and generates a user carpool request according to a user's input to the input unit 24. For example, the carpool request generation unit 201 outputs an icon or the like used to issue a carpool request to a touch screen display, and a carpool request is generated when the user clicks the icon. The carpool request generation unit 201 associates the generated carpool request with a user ID and transmits it to the server 30.

The user information generation unit 202 generates user information. The user information generation unit 202 shows an operating screen for promoting an input of user information on the output unit 25 and generates the user information according to a user's input to the input unit 24. The generated user information is transmitted by the carpool request generation unit 201 to the server 30 together with a carpool request. Note that the user information may be input by the user through the input unit 24 in advance and stored in the auxiliary memory 23 of the user terminal 20. The user information generation unit 202 may generate the user information based on data stored in the auxiliary memory 23. In addition, the user information generation unit 202 may generate the user information before the carpool request is generated and transmit it to the server 30. For example, the user information may be generated upon user registration and transmitted to the server 30. In this case, the user information is stored in the user information DB 311 of the server 30 in advance.

The travel information generation unit 203 generates user's travel information. The travel information generation unit 203 shows an operating screen for promoting an input of the travel information on the output unit 25 and generates the travel information according to a user's input to the input unit 24. The generated travel information is transmitted by the carpool request generation unit 201 to the server 30 together with a carpool request. Note that the travel information may be input by the user through the input unit 24 in advance and stored in the auxiliary memory 23 of the user terminal 20. The travel information generation unit 203 may generate the travel information based on data stored in the auxiliary memory 23. In a case where the user terminals 20 have a global positioning system (GPS), the positions of the user terminals 20 may be detected through reception of radio waves transmitted from satellites upon generation of the travel information, and the travel information generation unit 203 may determine these positions of the user terminals 20 as user's current locations. In a case where the in-car apparatus 100 of the vehicle 10 has a GPS, the in-car apparatus 100 may detect the position of the vehicle 10 by receiving radio waves transmitted from satellites and determine this position of the vehicle 10 as a driving user's current location. In this case, the in-car apparatus 100 has the same functions as the travel information generation unit 203. In this case, at predetermined time (for example, 60 seconds) intervals, information about the current location of the vehicle 10 detected through the GPS may be transmitted from the in-car apparatus 100 to the server 30 together with the user ID. The server 30 updates the driving user's current location stored in the travel information DB 312, based on the information transmitted from the in-car apparatus 100. Note that in a case of the automatic driving vehicle, the current location of the vehicle 10 detected through the GPS is transmitted from the in-car apparatus 100 to the server 30 at predetermined time intervals.

The status information generation unit 204 generates user's status information. The status information generation unit 204 shows an operating screen for promoting an input of the status information on the output unit 25 and generates the status information according to a user's input to the input unit 24. The generated status information is transmitted by the carpool request generation unit 201 to the server 30 together with a carpool request. Note that the status information may be input by the user through the input unit 24 in advance and stored in the auxiliary memory 23 of the user terminal 20. The status information generation unit 204 may generate the status information based on data stored in the auxiliary memory 23. In addition, the status information generation unit 204 may generate the status information before the carpool request is generated and transmit it to the server 30.

FIG. 3 is a diagram illustrating one example of a screen for inputting the user information, travel information, and status information shown on the output unit 25 of the user terminal 20. For the user ID, current location, destination, travel date and time, and test score, the users input text. In addition, whether the user is a driving user or a passenger user and the learning objective are selected when the user pushes an icon of a button prepared. Information input to the user terminal 20 is transmitted to the server 30 together with the carpool request.

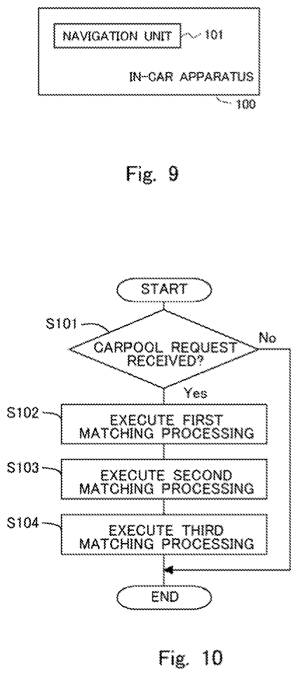

A functions of the in-car apparatus 100 of the vehicle 10 will now be described. FIG. 9 is a diagram illustrating an example of a functional configuration of the in-car apparatus 100. Each in-car apparatus 100 includes, as a functional component, a navigation unit 101. The processor 11 of the in-car apparatus 100 executes processing in the navigation unit 101 through computer programs in the main memory 12. Note that any one of the functional components or part of their processing may be executed with a hardware circuit.

The navigation unit 101 shows a map of an area at or around the current location of the vehicle 10 on the output unit 15 based on the map information and the like stored in the auxiliary memory 13. In addition, upon reception of a travel path from the server 30, the navigation unit 101 guides the path according to the received travel path. At the time, the navigation unit 101 outputs the travel path to the output unit 15 of the in-car apparatus 100. The navigation unit 101 shows, for example, a map and a travel path on the display or guides travel directions with a sound according to the travel path. The function of the navigation unit 101 can be implemented by using a well-known technique.

Although the travel paths are generated in the route generating unit 306 of the server 30 in this embodiment, this generation of the travel paths may be performed in the navigation unit 101 of the in-car apparatus 100. In this case, the server 30 transmits the travel information about each user matched to the in-car apparatus 100, and the navigation unit 101 generates a travel path based on the travel information about each user and the map information stored in the auxiliary memory 13. The map information stored in the auxiliary memory 13 is information equivalent to the map information stored in the map information DB 314 of the server 30.

Matching processing executed by the matching processing unit 305 in the server 30 will now be described. FIG. 10 is a flow chart of the matching processing according to this embodiment. The matching processing illustrated in FIG. 10 is repeatedly executed in the matching processing unit 305 at predetermined time intervals. The matching processing is processing for combining a driving user and passenger users.

In step S101, the matching processing unit 305 determines whether or not a carpool request has been transmitted from the user terminal 20. When a positive determination is made in step S101, the process proceeds to step S102, and when a negative determination is made, the flow chart is terminated.

In step S102, a first matching processing is executed based on information stored in the travel information DB 312. In the first matching processing, passenger users whose current location and destination are within an area a predetermined distance from a scheduled route of the travel of the driving user on the driving user's travel date and time are searched and combined. In a case of the automatic driving vehicle, no driving user exists, so that in the first matching processing, passenger users whose current location and destination are within an area a predetermined distance from a scheduled route of the travel of the automatic driving vehicle on the travel date and time of the automatic driving vehicle are searched and combined. In the first matching processing, more users than passengers that the vehicle 10 can contain may be matched. In the first matching processing, matching may be performed using a well-known matching technique based on the information stored in the travel information DB 312. Regarding a case, for example, where it is assumed that users having the same destination and travel date and time join a carpool such as where employees of the same company join a carpool to commute in the morning, the first matching processing may be omitted.

Subsequently, in step S103, a second matching processing is executed based on Information stored in the status information DB 313. In the second matching processing, users who have the same learning objective are selected among the users matched in the first matching processing and combined. Note that, in the second matching processing, more users than passengers that the vehicle 10 can contain may be matched. For example, for a manual-drive vehicle 10, a driving user rides on it with no exception and passenger users having the same learning objective as the driving user may be matched. The matching processing unit 305 refers to the learning objective field in the status information stored in the status information DB 313 and matches users for which the same learning objective is input. In a case where the driving user has no learning objective, passenger users having the same learning objective may be matched together. In a case where no passenger users who have the same learning objective as the driving user exist, or in a case of an automatic driving vehicle, passenger users who have the same learning objective may be matched together. When users having the same learning objective do not exist or when the number of users having the same learning objective is less than the seat capacity of the vehicle 10, users having different learning objectives may be matched or users having no learning objective may be matched, or users may be matched independently of their learning objectives. Thus, when a user having different learning objective rides on the vehicle 10 together, the opportunities of carpool can be increased.

In step S104, third matching processing is executed based on information stored in the status information DB 313. In the third matching processing, users whose scores have a difference within a predetermined range are selected among the users matched in the second matching processing and combined. In other words, in the third matching processing, users are matched so that a difference between the learning levels of the users falls within a predetermined range. The matching processing unit 305 refers to the score field in the status information stored in the status information DB 313 and matches users so that a difference between the scores of these users falls within the predetermined range. In the third matching processing, matching is performed so that the seat capacity of the vehicle 10 is respected. In a case where the number of users whose scores have a difference within the predetermined range is greater than the seat capacity of the vehicle 10, users are selected from them so that it becomes less than or equal to the seat capacity of the vehicle 10. At this time, users may be selected so that a difference between the scores of the users becomes smallest. Accordingly, higher learning effects can be obtained. Note that the order of processing in step S102, step S103, and step S104 may be changed. In this case, matching is performed in the final matching processing so that the number of users to join a carpool becomes less than or equal to the seat capacity of the vehicle 10.

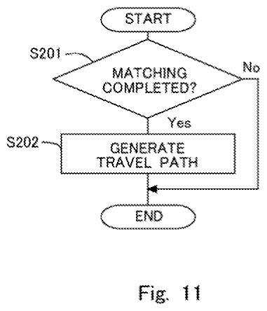

FIG. 11 is a flow chart illustrating a flow for generating the travel path (travel path generating processing). This flow chart is executed in the route generating unit 306 of the server 30 at predetermined time intervals. Note that the flow chart illustrated in FIG. 11 may follow the matching processing illustrated in FIG. 10. In step S201, whether or not user matching by the matching processing unit 305 has been completed is determined. When a positive determination is made in step S201, the process proceeds to step S202, and when a negative determination is made, the flow chart is terminated. In step S202, the travel path is generated so that users matched in the matching processing can join a carpool in the vehicle 10.

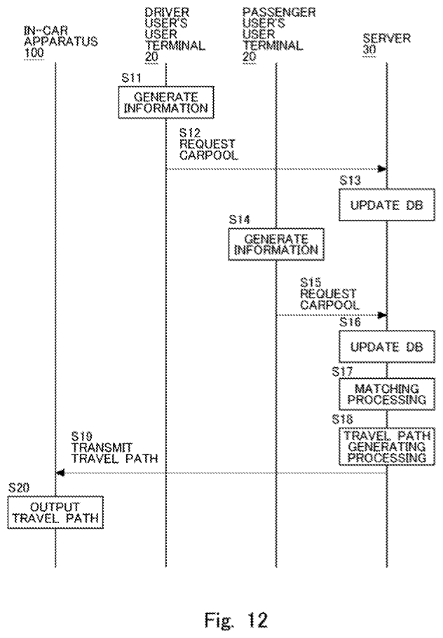

An operation of the carpool support system 1 will now be explained. FIG. 12 is a diagram illustrating a flow of the operation of the carpool support system 1. When the driving user and passenger users operate the input units 24 of their user terminals 20 to input the user information, the travel information, and the status information, each user terminal 20 generates the carpool request, the user information, the travel information, and the status information (processing in S11 and S14). Subsequently, each user terminal 20 transmits the carpool request, the user information, the travel information, and the status information to the server 30 (processing in S12 and S15). Upon reception of the carpool request, the user information, the travel information, and the status information, the server 30 updates the travel information DB 312 and the status information DB 313 each time (processing in S13 and S16).

In addition, upon reception of the carpool request, the server 30 executes the matching processing (processing in S17). In S17, the server 30 executes the matching processing illustrated in FIG. 10. The server 30 searches for users who can join a carpool based on the travel information and status information associated with the user IDs and combines them. Upon completion of matching, the server 30 generates a travel path based on the travel information of each user (processing in S18). In S18, the server 30 executes the travel path generating processing illustrated in FIG. 11. Information about the generated travel path is transmitted from the server 30 to the in-car apparatus 100 (processing in S19). The in-car apparatus 100 receiving the information about the travel path outputs the travel path to the output unit 15 and guides the driving user along the travel path (processing in S20). Note that the server 30 may transmit the travel path to the in-car apparatus 100 together with a notification of the completion of the matching and the travel path to each user terminal 20. Upon reception of the notification of the completion of the matching and the travel path, in each user terminal 20, the processor 21 outputs the notification of the completion of the matching and the travel path to the output unit 25. In a case of the automatic driving vehicle, instead of outputting the travel path in S20, the in-car apparatus 100 moves the vehicle 10 along the travel path.

As described above, according to this embodiment, in a case where the multiple users in a carpool in the vehicle 10 receive a learning in the vehicle 10, matching is performed according to the learning levels of the users and the travel path is generated so that the matched users can join the carpool, so that the learning content that each user demands can be given, which increases learning effects for each user.

### Other Embodiments

The above-described embodiment is merely illustrative and appropriate modification can be made without departing from the scope of the present disclosure. Although the multiple users are matched so that the difference between their learning levels falls within the predetermined range in the above-described embodiment, matching based on information about learning levels is not limited to this. For example, multiple users may be matched according to their learning levels from highest to lowest. At this time, matching is performed in such a manner that demanding users are sorted into multiple groups according to their learning levels from highest to lowest, and the members in the same group ride in the same vehicle for a carpool. In this case, the difference between the learning levels of the multiple users in a carpool does not necessarily fall within the predetermined range. However, since users with comparable learning levels are matched, higher learning effects can be obtained.

In a case where multiple users are already in the vehicle 10 or in a case where multiple users are already scheduled to ride in the vehicle 10, it is possible that a carpool request is transmitted from the user terminals 20 of other users to the server 30. In this case, if there is an empty seat in the vehicle 10, matching can be performed so that another user can be added as a user to join a carpool an the vehicle 10. In this case, users having the same learning objectives as the multiple users who are already in the vehicle 10 or the multiple users who are scheduled to ride in the vehicle 10 are matched. Further, among the matched users, users are selected and matched so that the difference between the learning level of each user and the learning level of the corresponding user of the multiple users who are already in the vehicle 10 or the multiple users who are scheduled to ride in the vehicle 10 fails within a predetermined range. When users to join the carpool in the vehicle 10 are added, the route generating unit 306 generates the travel path again so that the added users can ride in the vehicle 10.

The processing and units described in this disclosure can be freely combined unless technical inconsistencies arise.

In addition, processing supposed to be done with one device according to the above description may be executed with multiple devices. Alternatively, processing supposed to be done with different devices according to the above description may be executed with one device. In a computer system, the type of hardware configuration (server configuration) used to implement each function can be flexibly changed.

The present disclosure can be implemented when a computer program having the functions that have been described in the above embodiment implemented is supplied to a computer, and one or more processors in the computer read and execute the program. Such a computer program may be provided to the computer via a non-transitory computer-readable memory medium that can be connected to the computer's system bus or via a network. Examples of non-transitory computer-readable memory medium include any type of disks such as a magnetic disk (such as a floppy (registered trademark) disk and hard disk drive (HDD)), and an optical disk (such as CD-ROM, a DVD disk, and a Blu-ray disk), a read only memory (ROM), a random access memory (RAM), EPROM, EEPROM, a magnetic card, a flash memory, an optical card, and any type of media suitable for storing electronic instructions.

What is claimed is:

1. An information processing apparatus comprising a control unit, the control unit, in a case where a learning between multiple carpool users who are users in a carpool in a same vehicle is to be performed in the vehicle, matching the multiple carpool users to join the carpool in the vehicle, based on information about learning levels of multiple demanding users who are users demanding the carpool in the vehicle.

2. The information processing apparatus according to claim 1, wherein the control unit matches the multiple carpool users among the multiple demanding users such that a difference between the learning levels of the multiple carpool users falls within a predetermined range.

3. The information processing apparatus according to claim 1, wherein the control unit acquires information about the learning levels generated in terminals possessed by the multiple demanding users and transmitted from the terminals.

4. An information processing method comprising the steps of:
in a case where a learning between multiple carpool users who are users in a carpool in a same vehicle is to be performed in the vehicle, acquiring information about learning levels of multiple demanding users who are users demanding the carpool in the vehicle; and
matching the multiple carpool users to join the carpool in the vehicle, based on the information.

5. A program for causing the information processing method according to claim 4 to be executed by a computer.
